(19) United States
(12) Patent Application Publication
(10) Pub. No.: US 2008/0099577 A1
(43) Pub. Date: May 1, 2008

(54) Hydraulically Driven Pump-Injector with Multistage Pressure Amplification for Internal Combustion Engines

(76) Inventor: Boris Feinleib, Jerusalem (IL)

Correspondence Address: NATH & ASSOCIATES, 112 South West Street, Alexandria, VA, 22314, US

(21) Appl. No.: 11/658,035

(22) PCT Filed: Jul. 20, 2004
(86) PCT No.: PCT/IL04/00657

§ 371 Date: Jan. 22, 2007

(51) Int. Cl. F02M 47/04

(52) U.S. Cl. 239/88; 239/533.2

(57) ABSTRACT

Hydraulically driven pump-injector for internal combustion engines primarily for diesels, wherein in order to considerably increase the pressure multiplication coefficient for achieving super-high injection pressures (2500 Bar and higher) and decreasing the pump-injector diameter or reducing the pressure of the actuating fluid, a multistage pressure intensifier is installed in the pump-injector, comprising a tandem of successive stages, each stage comprising an intermediate piston (3), above which a working cavity (12) is formed, to which the actuating fluid is expulsed by a pushrod (4) driven by the previous piston.

### TECHNICAL FIELD

The proposed hydraulically driven pump-injectors with multistage pressure intensifier relate to the field of fuel supply systems for internal combustion engines, primarily to diesels.

### BACKGROUND ART

In conventional hydraulically driven pump-injectors, a single-stage mechanism of pressure intensification is used, comprising one power piston and a pumping plunger. In these systems, the increase of the injection pressure compared to the pressure of the actuating fluid (multiplication coefficient) equals the ratio of the cross-sectional areas of the power piston and pumping plunger, i.e., the ratio of their square diameters. Since the diameter of the power piston cannot be significantly increased (and the pumping plunger diameter cannot be significantly decreased) due to the lay-out limitations for pump-injectors disposed in cavities of conventional diesel cylinders, pressure multiplication coefficients and injection pressures in conventional hydraulically driven pump-injectors with single-stage pressure intensifier are limited. Normally, the pressure multiplication coefficient in this case does not exceed 8-10, and the injection pressures reach 600-1800 Bar maximum. However, a comprehensive technical solution allowing for increasing fuel efficiency and durability, while decreasing noise and especially emission levels in the entire operational envelope of the engine requires a considerable increase in injection pressure (up to 2500 Bar and more) along with ensuring flexible control of the forefront injection characteristic (multiphase injection, and “rate shape”). Increasing the injection pressure is especially important for large bore cylinder diesels used in heavy off roads, locomotives, marine applications and large power generation sets.

### DISCLOSURE OF INVENTION

Increasing the pressure multiplication coefficient to 15-20 and higher and, accordingly, increasing the injection pressure to 2500 Bar and higher without significantly increasing the dimensions of the pump-injector body diameter is achieved in the proposed hydraulically driven pump-injector by means of multiphase pressure intensification. In this case, the total pressure multiplication coefficient (m) equals the product of the multiplication coefficients of individual stages (m=m₁×m₂×m₃ . . . ). Therefore, the multiplication coefficients in each stage (m₁, m₂, m₃ . . . ) can be relatively small, and hence the power pistons' diameters can also be small.

The proposed hydraulically driven pump-injector with multistage pressure intensifier is implemented in the design environment comprising a body with inlet and outlet channels for the connection with a source of actuating fluid (accumulator or rail, which in turn is connected to the actuating fluid pump), and a drain tank or sump, respectively; in said body, cylindrical cavities of different diameters are disposed coaxially, in which a leading power piston and a pumping plunger are moving, a working cavity being formed above the leading power piston, and a high-pressure underplunger cavity being formed under the pumping plunger; in said body, in the area adjacent to the free part of the pumping plunger (which is not in the body aperture) a feeding cavity is also formed, which is constantly connected with the fuel supply system through a filling channel, which is also formed in the body, so that said feeding cavity is periodically connected with the underplunger cavity (when the pumping plunger is in the extreme upper position, i.e. in the dwell position). Said design environment also comprises a distributing device with a valve predominantly having an electromagnetic drive controlled by an electronic control unit (piezoelectric, magnetostriction, mechanical or other drives can also be used), also disposed in the pump-injector body and periodically connecting the working cavity of the leading power piston with the source of the actuating fluid or a drain tank through said inlet and outlet channels and the additional channel in the body, connecting said working cavity with the distributing device; a nozzle, which is attached to the pump-injector body and is constantly connected through a high-pressure channel formed in the body with the underplunger cavity; and a return mechanism (for instance, a spring mechanism) for the return of the leading power piston and pumping plunger to the initial extreme position after the end of the working stroke.

In order to achieve multiphase pressure multiplication between the leading power piston and pumping plunger, one or several pressure intensifiers are installed in the cylindrical cavities made in the body coaxially with the leading power piston and pumping plunger, forming a tandem. Each pressure intensifier comprises an intermediate power piston with a working cavity above it, and a pushrod expulsing the actuating fluid into the working cavity above the power piston of the subsequent pressure intensifier. Said intermediate pistons and pushrods have a precision joint with said pump-injector body, the pushrod of the pressure intensifier, adjoining the leading power piston, contacting said leading power piston and having a smaller diameter than the diameter of the leading power piston, and intermediate piston in the pressure intensifier adjoining the pumping plunger contacts said pumping plunger and has a larger diameter than the diameter of the pumping plunger. The diameters of all pushrods of built-in pressure intensifiers are smaller than the diameters of the respective intermediate pistons. In addition, in said intermediate pistons, axial and radial channels are made, and also a groove, which is constantly connected with above-piston cavity and periodically connected with the respective groove and channels made in said body, and through which the working cavities of the intermediate pistons are connected with said feeding cavity in the pump body when the intermediate pistons with leading power piston and pumping plunger are in the extreme upper position (dwell position).

By selecting the time during which the feeding cavities of the intermediate pistons are connected with said feeding cavity in the beginning of the pistons' working stroke (by changing the position of said piston channels in relation to the groove in the body), and also by selecting the dimensions of said channels, one can achieve rate shape, and control the time and intensity of the first low-intensity phase of the fuel injection.

### SUMMARY OF THE INVENTION

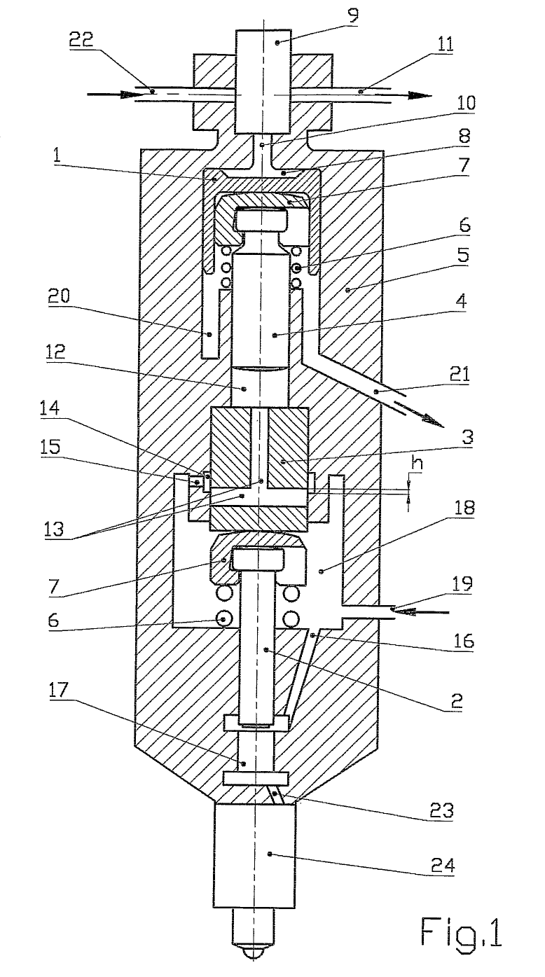

FIG. 1 shows a functional diagram of a hydraulically driven pump-injector with two pressure multiplication stages.

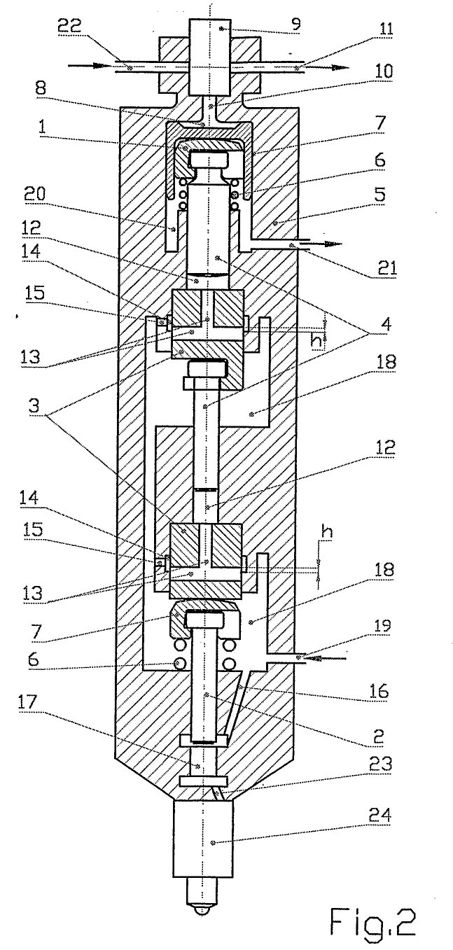

FIG. 2 shows a functional diagram of a hydraulically driven pump-injector with multistage (3 stages) pressure intensification.

In FIGS. 1 and 2:

1—leading power piston; 2—pumping plunger; 3—intermediate power pistons; 4—pushrods; 5—pump-injector body; 6—return mechanism spring; 7—disk of the return mechanism spring; 8—the working cavity of leading power piston 1; 9—distributing device; 10—the channel connecting distributing device with working cavity 8; 11—the channel connecting distributing device with the drain tank; 12—the working cavity of intermediate power piston 3; 13—channels of intermediate piston 3; 14—grooves in body 5; 15—the channels connecting groove 14 with feeding cavity 18; 16—the channel connecting underplunger cavity 17 with feeding cavity 18; 17—underplunger cavity; 18—feeding cavity; 19—the channel connecting feeding cavity 18 with the source of the actuating fluid or fuel supply system; 20—drain cavity under leading power piston 1; 21—the channel connecting drain cavity 20 with the drain tank; 22—the channel connecting distributing device 9 with the source of the actuating fluid; 23—the channel connecting underplunger cavity 17 with nozzle 24; 24—the nozzle

Hydraulically driven pump-injector with two multiplication stages in accordance with the invention operates as follows (see FIG. 1).

In the initial position, leading power piston 1 with pumping plunger 2, and intermediate power piston 3 and pushrod 4, moving in the cylindrical cavities of body 5 are in the extreme upper position (dwell position) due to the action of the spring mechanism (spring 6 and disk 7), and working cavity 8 of leading power piston 1 through channel 10 of distributing device 9 and channel 11 is connected with the drain tank.

At the same time, the actuating fluid (fuel) fills working cavity 12 of intermediate piston 3 through channels 13 in the intermediate piston, groove 14 and channel 15 in body 5, while through channel 16 under plunger cavity 17 is filled with fuel from feeding cavity 18 filled through channel 19. Drain cavity 20 under leading power piston 1 is constantly connected through channel 21 with the drain tank. When the valve electromagnet of distributing device 9 is energized, working cavity 8 of leading power piston 1 through distributing device 9 and channel 22 in body 5 is connected with the source of the actuating fluid (accumulator, or Rail). Due to the action of the actuating fluid, leading power piston 1 pushes pushrod 4, causing an increase in the pressure in said working cavity 12 after channels 13 are disconnected by groove 14. In working cavity 12 of intermediate piston 3 the pressure equals the product of the actuating fluid pressure and the ratio of the squares of the diameters of intermediate piston 3 and pushrod 4 (i.e., multiplication coefficient “m₁” of the first stage of the pressure intensification). Due to the increased pressure in said working cavity 12, intermediate piston 3 with pumping plunger 2 performs a working stroke, and pumping plunger 2 through channel 23 expulses the fuel into nozzle 24. The resulting injection pressure equals the product of the pressure in the working cavity 12 and the ratio of square diameters of intermediate piston 3 and pumping plunger 2, i.e. multiplication coefficient, “m₂” of the second stage of the pressure intensification. The total multiplication coefficient, “m” of the pump-injector in accordance with the invention will then equal the product of the multiplication coefficients of individual stages (m=m₁×m₂). When the electromagnet of the valve of distributing device 9 is de-energized, working cavity 8 of leading power piston 1 is connected through channel 10, distributing device 9 and channel 11 with the drain tank the pressure in working cavity 8 of leading power piston 1 falls, and due to the action of the spring mechanism (spring 6 with disk 7) all parts of the device (leading power piston 1, pushrod 4, intermediate piston 3 with pumping plunger 2 return to the initial upper position (the dwell position).

In the proposed pump-injector, change in the cyclic fuel delivery is achieved by changing the value of the working stroke of pistons with plunger by changing the duration of the electric signal fed from the electronic control unit to the electromagnet of the valve of distributing device 9.

As mentioned above, by changing the “h” value (see FIG. 1), i.e. the travel of intermediate piston 3 before channels 13 of intermediate piston 3 are disconnected from groove 14 in body 5, as well as by changing the dimensions of channels 13 in said piston 3, we can change the intensity and duration of the initial, low-intensity phase of the injection and thus control the rate shape.

Hydraulically driven pump-injector with multiphase (3 stages) pressure intensification according to FIG. 2 operates similarly to the above. However, the total multiplication coefficient, “m” will equal the product of the three multiplication coefficients of the stages, m=m₁×m₂×m₃, allowing for achieving extremely high values for pressure multiplication in the entire pump-injector.

### BEST MODE FOR CARRYING OUT OF INVENTION

The use of hydraulically driven pump-injector with multistage pressure intensifier is more efficient when fuel injected into the combustion chamber is used as the actuating fluid. In this case, the actuating fluid that fills working cavity 12 of intermediate piston 3 has a relatively high pressure (100-200 Bar), and shorter part of the working stroke of intermediate piston 3 will be spent on compressing the fluid in said working cavity. In addition, using fuel as actuating fluid allows for simplifying the design of the pump-injector, because feeding cavities 12 and intermediate pistons 3 can be filled directly from feeding cavity 18, which is constantly connected through channel 19 with the source of the actuating fluid.

The proposed multistage pressure intensifier can also be used in pump-injectors in which oil is used as actuating fluid. In this case, channels 15 in the body should not be connected with feeding cavity 18, but are instead connected by an autonomous channel formed in the body directly with the source of the actuating fluid (oil).

It is desirable that the leading and intermediate power pistons, pumping plunger, and pushrods can move directly in the body of the pump-injector, having precision joints with said body, as shown in FIGS. 1 and 2. However, out of manufacturing considerations it is possible to dispose the above-mentioned elements in individual bodies mounted in the pump-injector body.

It will be evident to those skilled in the art that the invention is not limited to the details of the foregoing illustrated embodiments in part of summary and mode of invention and that the present invention may be embodied in other specific forms without departing from the spirit or essential attributes thereof. The present embodiments are therefore to be considered in all respect as illustrative and not restrictive, the scope of the invention being indicated by the appended claims rather than by the foregoing description, and all changes which come within the meaning and range of equivalency of the claims are therefore intended to be embraced therein.

### INDUSTRIAL APPLICABILITY

Hydraulically driven pump-injector with multistage pressure intensifier can be used in all types of diesels that have requirements for outer pump-injector diameter, determined by the allowed dimensions of the cavity of the diesel engine head in which the pump-injector is mounted. The use of hydraulically driven pump-injector with multistage pressure intensifier can be especially efficient in high-power diesels, where high injection pressures must be achieved (2500 Bar and higher). Hydraulically driven pump-injector with multistage pressure intensifier can also be used in cases when the actuating fluid pressure must be significantly reduced. The proposed multistage pressure intensifier can also be used in other mechanical devices used for significant increase in the force of the actuating mechanism, for instance, in various hydraulic presses.

I claim:

1. Hydraulically driven pump-injector for internal combustion engines, primarily for diesels comprises: a body with inlet and outlet channels for the connection with a source of actuating fluid (accumulator or rail, which in turn is connected to the actuating fluid pump), and a drain tank or sump, respectively, in said body cylindrical cavities of different diameters being disposed coaxially, in which a leading power piston and pumping plunger are moving, a working cavity being formed above the leading power piston, and a drain cavity being formed under the piston, and a high-pressure under plunger working cavity being formed under the pumping plunger, a feeding cavity being also formed in said body in the area adjacent to the free part of the pumping plunger (which is not in the body aperture), which is constantly connected with the fuel supply system through a filling channel, which is also formed in the body, so that said feeding cavity is connected with the under plunger cavity when the pumping plunger is in the extreme upper position, i.e. in the dwell position, a channel being also formed in said body, through which the drain cavity under the leading power piston is connected with the drain tank; a distributing device with a valve predominantly having an electromagnetic or piezoelectric drive controlled by an electronic control unit (magnetostriction, mechanical or other drives can also be used), disposed in the pump-injector body and periodically connecting the working cavity of the leading power piston with the source of the actuating fluid or a drain tank (or sump) through said inlet and outlet channels and the additional channel in the body, connecting said working cavity with the distributing device; a nozzle, which is constantly connected through high-pressure channel formed in the body, with the under plunger cavity; and a return mechanism (for instance, a spring mechanism) for returning the leading power piston and pumping plunger to the initial extreme upper (dwell) position after the end of the working stroke, said pump-injector being distinguished by the fact that in said body, one or several successive pressure intensifiers are mounted between the leading power piston and pumping plunger in cylindrical cavities made in said body coaxially with the leading power piston and pumping plunger, their parts forming a tandem, each pressure intensifier comprising an intermediate power piston with a working cavity above it, and a pushrod expulsing the actuating fluid while moving into the working cavity above the power piston of the following pressure intensifier, said intermediate pistons and pushrods forming precision joints with said pump-injector body, the pushrod of the pressure intensifier adjoining the leading power piston contacting said leading power piston and having a smaller diameter than the diameter of the leading power piston, while the intermediate piston in the pressure intensifier adjoining the pumping plunger contacts said pumping plunger and has a larger diameter than the diameter of the pumping plunger, all pushrods of built-in pressure intensifiers having smaller diameters than the diameters of the respective intermediate pistons.

2. Hydraulically driven pump-injector according to 1, wherein said feeding cavity is constantly connected with the source of the actuating fluid (if fuel is used as the actuating fluid).

3. Hydraulically driven pump-injector according to 2, wherein in said intermediate pistons of built-in pressure intensifiers axial and radial channels are made, as well as an annular groove, which is constantly connected with above-piston cavities of the pistons and periodically connected with the respective grooves and channels, made in said body and through which the working cavity of the intermediate pistons is connected with said filling cavity in the pump-injector body when the intermediate pistons with leading power piston and pumping plunger are in the extreme upper position (dwell position).

4. Hydraulically driven pump-injector according to 3, wherein intermediate pressure intensifiers have autonomous bodies mounted in the pump-injector body.
